(19) United States
(12) Patent Application Publication
(10) Pub. No.: US 2025/0121474 A1
(43) Pub. Date: Apr. 17, 2025

(54) Method for Producing an Electrode, Electrode and Energy Storage Cell

(71) Applicant: Bayerische Motoren Werke Aktiengesellschaft, Muenchen (DE)

(72) Inventors: Desiree GRIESSL, Muenchen (DE); Martin HILLER, Karlsfeld (DE); Michael WAGNER, Muenchen (DE)

(21) Appl. No.: 18/688,575

(22) PCT Filed: Sep. 5, 2022
(86) PCT No.: PCT/EP2022/074555

§ 371 Date: Mar. 1, 2024

(30) Foreign Application Priority Data
Oct. 1, 2021 (DE) 10 2021 125 494.9

(51) Int. Cl. B24C 1/00; B24C 3/12; H01M 4/02; H01M 4/04; H01M 4/66

(52) U.S. Cl. CPC B24C 1/003; B24C 3/12; H01M 4/0404; H01M 4/0435; H01M 4/661; H01M 2004/021; H01M 2004/027

(57) ABSTRACT

A method for producing an electrode for an electrical energy storage cell includes the steps of providing a carrier material, coating the carrier material with coating material for producing a coating, and blasting the coating, in particular for adjusting the porosity thereof.

### BACKGROUND AND SUMMARY

The present invention relates to a method for producing an electrode for an electrical energy storage cell, an electrode, and an energy storage cell.

In electrical energy storage cells, such as lithium-ion cells, liquid electrolytes are used to ensure the ion transport between the battery electrodes. The electrolyte distribution significantly influences the ionic conductivity and the discharge capacity of the cell and is thus a decisive factor for the performance and quality of the cell. For this reason, complete and uniform permeation of the pore volume of the coating of the electrode with electrolyte is desired. For this purpose, the cells have to be stored for a long time after the electrolyte filling in order to enable the distribution of the electrolyte, driven by capillary forces, within the electrode structure. To increase the volumetric energy density as much as possible and improve the contacting of the particles within the coating of the electrode, the electrodes, thus the current collector foils coated with coating material, are calendered. The coating surface is compacted and cavities within the coating are reduced in size in this case. In addition to the above-mentioned positive effects which accompany the calendering, however, this process also has the result that the soaking of the electrolyte into the electrode coating is obstructed. The electrolyte filling accordingly takes longer, which slows the production process and makes it more costly.

It is therefore an object of the present invention to provide a method for producing an electrode, an electrode, and an energy storage cell, which eliminate the above-mentioned disadvantages, wherein in particular an electrode is provided which meets the highest performance requirements with low production costs at the same time.

This object is achieved by a method, by an electrode, and by an energy storage cell, in accordance with the independent claims. Further advantages and features result from the dependent claims and the description and the appended figures.

According to the invention, a method for producing an electrode for an electrical energy storage cell comprises the following steps:
providing a carrier material;
coating the carrier material with coating material to create a coating;
blasting the coating, in particular to activate or roughen it.

The carrier material is typically a, preferably metallic, carrier foil, also called a collector foil. Copper is typically used as the material for the carrier material or the carrier foil of the anode, and an aluminum foil is typically used for the carrier material or the carrier foil of the cathode. Typical foil thicknesses vary depending on the cell design between 4 μm and 25 μm. The carrier materials/carrier foils are preferably coated over a width of up to 900 mm in a roll-to-roll process. The coating can take place on one or both sides, sequentially or simultaneously. The coating can advantageously be activated or roughened via the blasting. For example, a porosity of the coating is expediently changed or adjusted, expediently in particular increased, at least close to the surface, by means of blasting.

Blasting technology is a subfield of surface technology in which blasting agents are guided at high speed onto a workpiece. Compressed air, compressed liquids, electrostatic or electromagnetic fields, and impellers are available as energy carriers. The blasting result is substantially dependent on the type of the selected blasting agent, in addition to the method control itself. Depending on the type of the method control and the blasting agents used, greatly varying technical effects can be achieved. In the present case, blasting is preferably used to activate the coating, in particular to roughen it and/or to create pores. Further possible effects which can be subsumed under the expression “activating” are in addition: solidifying, roughening, structuring, or causing abrasive effects in general.

According to one preferred embodiment, compressed air blasting is used in the present case. A preferably solid blasting agent is used in this case, which is accelerated by compressed air as it flows through a nozzle. Due to the impact of the blasting agents on the surface of a workpiece to be processed, in the present case the coating, this can be removed, solidified, and/or formed or structured, wherein the above-mentioned list is not to be understood as exhaustive.

According to one particularly preferred embodiment, the method comprises the following step:
blasting by means of CO₂ snow jets.

CO₂ snow blasting is a preferred compressed air method since the abrasive effect is very minor and is thus optimally suitable for the above-mentioned purpose. Moreover, no residues are retained, which would possibly influence the chemistry of the coating. Carbon dioxide is used as the blasting agent in CO₂ snow blasting.

A two-material ring nozzle is preferably used in the present case, since this method variant is less abrasive. Alternatively, a blasting nozzle having an agglomeration chamber can also be used.

In the present case in CO₂ snow blasting, CO₂ snow particles are expediently accelerated with the aid of a compressed air jet onto the coating, where they have, inter alia, an abrasive effect. In this way, small channels and/or pores are created there, through which the electrolyte can penetrate and distribute itself. The permeation of the pore volume of the coating is accelerated and the service life of the cell after the electrolyte filling can be shortened. This results in a significant reduction of the production costs for energy storage cells or electrodes.

The method preferably comprises the following step:
blasting after the calendering of the coating.

During calendering, the coated carrier material is compacted by one or more rotating pairs of rollers. A defined linear pressure is generated in this case, via which the porosity of the coating is reduced and the contacting of the particles within the coating is improved. These two procedures can now advantageously be decoupled from one another by the subsequent blasting of the coating. In particular, for example, the porosity can be increased again via the blasting after the calendering.

According to one embodiment, the method comprises the following step:
moving the carrier material during the blasting.

The blasting is expediently integrated directly or immediately into the roll-to-roll process. The blasting expediently takes place directly after the calendering and is integrated into the roll-to-roll process. The device for blasting or the blasting device is expediently installed fixed in place for this purpose while the carrier material or the carrier foil is moved. This can take place continuously or intermittently in accordance with the blasting.

The device for blasting comprises, according to one embodiment, multiple nozzles which are installed, for example, in a row transverse to the web direction. The nozzles can be designed as fixed or movable, so that if needed a blasting angle relative to the coating surface can also advantageously be adjusted.

According to one embodiment, the method comprises the following step:
local or regional blasting.

According to one embodiment, it can be advantageous not to blast the entire coating over the full surface. The regional or local blasting enables only local or regional activation or regional adjustment of the properties of the coating/electrode. Strips in which the porosity is increased can be created, for example, along a web direction of the electrode web.

According to one preferred embodiment, the blasting is guided so that the coating is uniformly blasted, the coating is thus activated as uniformly as possible in all areas.

According to one embodiment, the method comprises the following step:
intermittent blasting.

In intermittent blasting, an area of the coating is blasted using, for example, only one, possibly also multiple blasting strikes. The intermittent blasting can be advantageous if the coating is only to be processed as close as possible to the surface.

Alternatively, continuous blasting takes place. The blasting device runs continuously in this case.

According to one embodiment, the method comprises the following steps:
unrolling the carrier material;
coating the carrier material;
preferably drying the coating;
calendering the coating;
blasting the coating;
rolling up the carrier material.

The above-mentioned method chain can also include the method step of “slitting”, which is a severing process in which a broad electrode band (mother coil) is divided into multiple smaller electrode bands (daughter coil). In the present case, the blasting is expediently integrated into the roll-to-roll process, cf. the above-mentioned unrolling or rolling up. For this purpose, multiple means for blasting, in particular CO₂ snow blasting nozzles, are expediently combined to form an array (cf. the above-mentioned row) and attached above the electrode web passing through underneath. Complete blasting over the entire coating width can thus be enabled.

The method expediently comprises the following step:
providing a plurality of blasting nozzles, in particular transversely to a web direction of the carrier material.

The compaction of the electrode surface or the coating by the calendering has the result in particular for cathodes that the soaking of the electrolyte into the coating is made more difficult. Accordingly, the electrode is preferably a cathode in the present case.

Furthermore, the invention is directed to an electrode, in particular a cathode, in particular produced according to the method according to the invention, wherein the porosity of the electrode coating is adjusted by means of blasting, in particular CO₂ snow blasting. The advantages mentioned in conjunction with the method apply analogously and correspondingly to the electrode.

Furthermore, the invention is directed to an energy storage cell, comprising an electrode according to the invention. According to one preferred embodiment, the energy storage cell is an energy storage cell as is used in an energy storage device for partially or fully electrically operated motor vehicles. Energy storage cells of the type under discussion are energy storage cells which are filled with a liquid electrolyte.

Further advantages and features result from the following description of an embodiment of the method with reference to the appended figures.

### BRIEF DESCRIPTION OF THE DRAWINGS

FIG. 1 is a schematic illustration of an embodiment of the method according to the invention; and

FIG. 2 is a top view of the schematic illustration of FIG. 1.

### DETAILED DESCRIPTION OF THE DRAWINGS

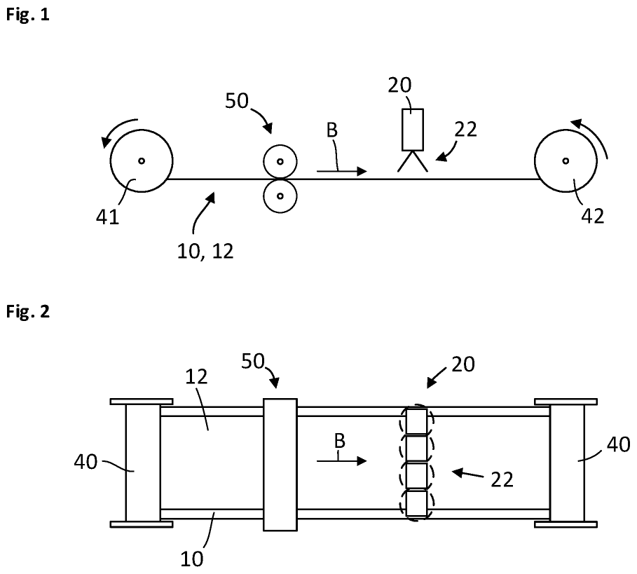

FIG. 1 shows a side view of an electrode, comprising a carrier material or a carrier foil 10 and a coating 12, wherein this cannot be seen as such in the side view due to its small thickness. A roll-to-roll process is shown. The electrode material is unrolled from a roll 41 here in order to then be rolled up again on a roll 42. Multiple method steps take place in between. In particular, after a coating process (not shown here), calendering takes place, cf. the calendering rollers 50. The porosity of the coating 12 is adjusted, in particular reduced in this case, and the contacting of the particles within the coating 12 is increased. The reference sign B identifies a web direction of the carrier material 10 or the electrode web. Blasting of the coating 12 expediently takes place immediately after the calendering, in the present case only shown from one side. For this purpose, a blasting device 20 is arranged relative to the electrode web. The blasting device 20 is in particular a device for CO₂ snow blasting. Reference sign 22 indicates a jet or a jet direction, which is directed for activation onto the coating 12.

FIG. 2 shows a top view of the sketch known from FIG. 1. In particular, it can be seen here that the blasting device 20 comprises multiple nozzles in the present case, so that in the present case a total of four jets 22 can be generated, indicated via the dashed circles. As a result, the coating 12 can be blasted over the full surface or completely while it is simultaneously moved along the web direction B. The jets 22 are oriented according to one preferred embodiment essentially perpendicular to the coating 12. Alternatively, however, it is also possible to work using different angles here in order to influence the blasting action.

### LIST OF REFERENCE SIGNS

10 carrier material
12 coating
20 blasting device
22 jet
41 roll
42 roll
50 calendering rollers
B web direction

1.-11. (canceled)

12. A method for producing an electrode for an electrical energy storage cell, the method comprising the steps of:
providing a carrier material;
coating the carrier material using coating material to create a coating;
blasting the coating in order to activate or roughen the coating.

13. The method according to claim 12, wherein the blasting is carried out by CO₂ snow blasting.

14. The method according to claim 13, wherein the blasting is carried out after calendering of the coating.

15. The method according to claim 12, further comprising the step of:
moving the carrier material during the blasting.

16. The method according to claim 12, wherein the blasting is carried out locally or regionally.

17. The method according to claim 12, wherein the blasting is carried out intermittently.

18. The method according to claim 12, further comprising the steps of:
unrolling the carrier material and then coating the carrier material;
calendering the coating and then blasting the coating; and
rolling up the carrier material.

19. The method according to claim 12, wherein the blasting is carried out with a plurality of blasting nozzles arranged transversely to a web direction of the carrier material.

20. The method according to claim 12, wherein the electrode is a cathode.

21. The method according to claim 12, wherein the blasting adjusts a porosity of the coating.

22. An electrode, comprising:
a carrier material;
a coating coated on the carrier material,
wherein a porosity of the electrode coating is adjusted by CO₂ snow blasting.

23. An energy storage cell comprising an electrode according to claim 22.
